(19) United States
(12) Patent Application Publication
(10) Pub. No.: US 2013/0212159 A1
(43) Pub. Date: Aug. 15, 2013

(54) Method, Apparatus and System for Intercepted Triggering of Execution of Internet Services

(71) Applicants: Konstantinos Vandikas, Solna (SE); Karl-Johan Lundkvist, Solna (SE); Ioannis Fikouras, Stockholm (SE); Göran Eriksson, Norrtalje (SE)

(72) Inventors: Konstantinos Vandikas, Solna (SE); Karl-Johan Lundkvist, Solna (SE); Ioannis Fikouras, Stockholm (SE); Göran Eriksson, Norrtalje (SE)

(73) Assignee: TELEFONAKTIEBOLAGET L M ERICSSON, STOCKHOLM (SE)

(21) Appl. No.: 13/574,111

(22) PCT Filed: Jan. 27, 2010
(86) PCT No.: PCT/EP10/50909

§ 371 Date: Nov. 16, 2012

(51) Int. Cl. H04L 29/08

(52) U.S. Cl. CPC H04L 67/02
USPC 709/203

(57) ABSTRACT

The Invention relates to dynamic execution or triggering of internet services. A dynamic execution of interne services accordingly comprise intercepting (S2OO) a first message sent from a source entity to a destination entity to obtain an intercepted message; determining (S200) whether at least one triggering condition Is given based on said intercepted message, the triggering condition associated to execution of at least one interne service; invoking (S300) said at least one interne service, if it is determined that said at least one triggering condition is given; creating (S400) a second message based on said at least one invoked interne service.

### TECHNICAL FIELD

The present invention is directed to a method, apparatuses, system and computer program for intercepted triggering of execution of internet services. More in detail, the present invention is directed to detecting or generating triggers that result in the execution of internet services, wherein the triggers are generated on the basis of intercepted messages.

### BACKGROUND

Internet services, also known as web-services, are well known in the art as providing services to a user over a network like the internet. Internet services typically consist of software components which can be accessed over a communications network. As also explained in the following, there are different technical problems related to the implementation of advanced services as well as limitations to the development and execution of new services due to constrains imposed by certain network elements.

As stated by W3C an internet service (also known as a web service) is a software system designed to support interoperable machine-to-machine interaction over a network. Such services have an interface described in a machine-processable format (specifically Web Services Description Language WSDL). Other systems can interact with the web service in a manner prescribed by its description using SOAP messages, typically conveyed using HTTP with an XML serialization in conjunction with other web-related standards.

Web services are frequently just Internet Application Programming Interfaces (API) that can be accessed over a network, such as the Internet, and executed on a remote system hosting the requested services. Other approaches with nearly the same functionality as web services are Object Management Group's (OMG) Common Object Request Broker Architecture (CORBA), Microsoft's Distributed Component Object Model (DOOM) or Sun Microsystems's Java/Remote Method Invocation (RMI).

In addition Representational State Transfer (RESTful) web services are gaining popularity, particularly with Internet companies. By using the PUT, GET and DELETE HTTP methods, alongside POST, these are often better integrated with HTTP and web browsers than SOAP-based services. They do not require XML messages or WSDL service-API definitions. Those internet services are however typically static, meaning that they respond to the use scenario of a first device requesting for a specific service and the device providing the service responding accordingly, as depicted for instance in FIG. 11.

Mashups are currently a popular and simple way for users without professional software engineering competence, to create new services by combing/aggregating other existing services. A simple example of a mashup could be a situational application, portraying the places a users has visited on a map, a concept of certain significance to a specific target group.

A mashup is formulated as a web page or as an application that combines data or functionality from one or more external sources to create a new service. By definition, a mashup is meant to be flexible in the way that it accumulates information from external sources. To be more exact, the response one receives froth a mashup, even though it may be the result of an aggregation of multiple external sites, it still remains static in the sense that in order to update it or improve it, one must re-design the mashup and re-deploy afterwards.

Web site interaction nowadays, whether it happens on self-contained web sites or in sites that are products of a combination of several sites (mashups), in their vast majority, entails using an input element such as a text box and submitting a request. A common example of such an interaction is Google's Search page were a user submits a request of a search query and receives back a collection of relevant results ranked accordingly to their relevance, accompanied by advertisements that seem adequate to the original query and collection of results. Additionally, throughout the definition of their request, a user can optionally use special keywords that have a certain meaning, certain semantics for the corresponding web site that would, thereafter, be processing their request. Returning to our original example of the Google Search page, one is allowed to use “London AND Queen Elizabeth” and retrieve a collection of results combining both keywords, since the AND operator has a special meaning for the query and allows for joining both sets of results. Finally yet importantly, as the user is typing her request, the text box will be extended with a drop down list that contains suggestions, regarding this user's query. Such type of interactions is thus achieved by means of an applications running on a server, where this application interacts with an input given by a user. Thus, such applications are confined to the direct interaction with the user with a running application as selected by and executed directly for a user.

Intercepting proxies are also known in the art. An intercepting proxy combines a proxy server with a gateway or router (commonly with NAT capabilities). Connections made by client browsers through the gateway are diverted to the proxy without client-side configuration (or often knowledge). Connections may also be diverted from a SOCKS server or other circuit-level proxies. Intercepting proxies are also commonly referred to as “transparent” proxies, or “forced” proxies, presumably because the existence of the proxy is transparent to the user, or the user is forced to use the proxy regardless of local settings. Intercepting proxies are commonly used in businesses to prevent avoidance of acceptable use policy, and to ease administrative burden, since no client browser configuration is required. This second reason however is mitigated by features such as Active Directory group policy, or DHCP and automatic proxy detection. Intercepting proxies are also commonly used by ISPs in some countries to save upstream bandwidth and improve customer response times by caching. This is more common in countries where bandwidth is more limited (e.g. island nations) or must be paid for. The diversion/interception of a TCP connection creates several issues. Firstly the original destination IP and port must somehow be communicated to the proxy. This is not always possible (e.g. where the gateway and proxy reside on different hosts). There is a class of cross site attacks which depend on certain behaviour of intercepting proxies that do not check or have access to information about the original (intercepted) destination. This problem can be resolved by using an integrated packet-level and application level appliance or software which is then able to communicate this information between the packet handler and the proxy. Intercepting also creates problems for HTTP authentication, especially connection-oriented authentication such as NTLM, since the client browser believes it is talking to a server rather than a proxy. This can cause problems where an intercepting proxy requires authentication, then the user connects to a site which also requires authentication. Finally intercepting connections can cause problems for HTTP caches, since some requests and responses become un-cacheable by a shared cache. Therefore intercepting connections is generally discouraged. However due to the simplicity of deploying such systems, they are in widespread use. It is often possible to detect the use of an intercepting proxy server by comparing the client's external IP address to the address seen by an external web server, or sometimes by examining the HTTP headers received by a server. A number of sites have been created to address this issue (such as whatismyip.com), by reporting the user's IP address as seen by the site back to the user in a web page.

Thus, as seen above, the use of interception proxies is discouraged since it often introduces problems in the use and development of communications network.

Most chatting environments, whether they are standalone or web-based applications, follow a similar interaction pattern such as the one mentioned in the previous paragraph. The user is presented with a text box where she is allowed to type in the message to be sent to the corresponding chat buddy. Throughout the definition of that text she is allowed to use emoticons or special symbols that have specific semantics for the chat service she using and for the other participants of this service. For example if she using twitter and she types “@costa44 hello” she would be sending this message to user costa44. Moreover, the user of chat service is allowed on the client-side to define her associations between symbols and their semantics. For example, in Microsoft Messenger, a user is allowed to associate an abbreviation with an animated image so every time she writes that, an animated image gets sent to her chat buddy. This approach is referred us client-side preprocessing. On the opposite plane, the server-side, there are twitter services such as Aardvark which allow a user to type in a question such as “Where should I go hiking?”, forward this question to an expert user and then get back a response based on the experts analysis.

Finally yet importantly, a recent service coined by jajah and twitter allows users to use an expression such as “call @username” for third party call establishment and thus extend the existing functionality offered by twitter.

However, those services rely on the execution of a software component by the device which was requested to provide a given internet service. Thus, the information that can be provided is static and limited to the execution of the internet service by that device; in other words, it is difficult to extend and enhance internet services.

One problem common to at least some of the prior art techniques described above relates to the interaction with remote services.

One further common problem lies in the interaction with remote services based on specific symbols. As portrayed in FIG. 12, for instance, Message A is send from Node A (1201) to Node B (1205) and based on a vocabulary (1210), it's tokens are analyzed and are transformed thus leading to a new message A′. Optionally the message maybe later on relayed to Node C (1215) and so on.

One of the limitations we are witnessing in the current state of the art is that the vocabulary is isolated within the confines of the provider that is offering a specific service (e.g. chat). This means that the user is not allowed to extend this vocabulary based on her preferences.

As mentioned above, the only known approach for extending such functionally is offered on the client-side, on a per application basis, where the user is allowed, locally, to define her private associations between symbols and actions. However, these associations are localized for her setup solely and are not communicated to the end service.

The isolated nature of currently known approaches acts as an obstacle to third party companies that are interested in providing value-add extensions to a global service. Currently, this can only be achieved through labor intensive system integration and extension of the application as well as the API offered in the network to include the new value-add functionality. Furthermore, such extensions typically require a re-deployment. These limitations attribute a static nature to a mash up. Consequently, this approach, due to its labor intensive and static nature leads to significant overhead in value-add service development.

To sum up, two main issues are found in regards of web interaction patterns, web services and aggregation of web services.

A first issue relates to the static nature of mash-up types of web services. Meaning that even though a mash up-web service aggregates data from many sources it will still need to be redeployed in order to modify its behavior or add new data sources. Thus, aggregation of internet services is not capable of truly providing dynamic and enhanced content or information to a requesting device.

A second problem mentioned is that the vocabulary is isolated within the confines of the provider that is offering a specific service (i.e. chat). This means that the user is not allowed to extend this vocabulary based on her preferences.

The prior art solutions, therefore, lack from flexibility in assembling internet services, from the possibility of providing less static solutions of from the possibility of providing more efficiently enhanced content or information.

### SUMMARY OF THE INVENTION

It is an object of the present invention to overcome at least some of the technical problems of the prior art. It is furthermore an object of the present invention to provide a method, network entities, a system and a computer program for dynamic execution or for dynamic triggering of internet services, which provide a more flexible and improved way of allowing internet services to co-operate while providing enhanced information or content to network entities.

According to a first aspect of the invention, it is provided a method for dynamic execution of internet services, comprising a step of intercepting a first message sent from a source entity to a destination entity to obtain an intercepted message. The method further comprises a step of determining whether at least one triggering condition is given based on said intercepted message, the triggering condition associated to execution of at least one internet service; and a step of invoking said at least one internet service, if it is determined that said at least one triggering condition is given. According to the method, it is further foreseen a step of creating a second message based on said at least one invoked internet service.

According to a second aspect of the invention, it is provided a network entity for dynamic triggering of internet services, the network entity comprising a message receiver entity, an examining entity and a trigger entity. The message receiver entity is for receiving an intercepted message corresponding to a first message sent from a source entity to a destination entity. The examining entity is for examining the content of said intercepted message to create an examination result; and the trigger entity is for generating at least one triggering condition associated to execution of at least one internet service. The trigger entity is further adapted to generate the at least one triggering condition when the examination result satisfies predetermined conditions.

According to a third aspect of the invention, it is provided a network entity for dynamic invocation of internet services, comprising a database, a controller entity and an invoker entity. The database is for storing policies related to execution of internet services, while the controller entity is for retrieving from said database a policy corresponding to a triggering condition received from a further network entity, the triggering condition determined on the basis of an intercepted message. The invoker entity is for invoking an internet service, said invoked internet service determined based on said policy. The controller entity according to the network entity of this aspect of the invention is further adapted to receive a response from said internet service and for forwarding a reply message based on said response to said further network element.

According to a further aspect of the invention, it is provided a system for dynamic execution of internet services, the system comprising an intercepting entity, controlling entity, an invoking entity and a message creator. The intercepting entity is for intercepting a first message sent from a source entity to a destination entity to obtain an intercepted message. The controlling entity is for determining whether at least one triggering condition is given on the basis of said intercepted message, the triggering condition associated to execution of at least one internet service. The invoking entity is for invoking said at least one internet service, if it is determined that said at least one triggering condition is given. The message creator is for creating a second message on the basis of said at least one invoked internet service.

According to a further aspect of the invention, it is provided a computer program for performing dynamic execution of internet services, the computer program comprising instructions configured, when executed on a programmable system, to cause the programmable system to carry out the method steps according to the present invention.

Further advantageous embodiments are defined in the dependent claims. Further examples are provided in the description for facilitating the understanding of the invention and explaining further details and advantages related to the invention.

### BRIEF DESCRIPTION OF THE DRAWINGS

FIG. 1 illustrates a flow chart according to an embodiment of the present invention;

FIG. 2 is an illustrative block diagram of a network entity for dynamic triggering of internet services according to an embodiment of the present invention;

FIG. 3 is an illustrative block diagram of a network entity for dynamic invocation of internet services according to an embodiment of the present invention;

FIG. 4 is an illustrative block diagram of a system for dynamic execution of internet services according to an embodiment of the present invention;

FIG. 5 is an illustrative block diagram of a further embodiment of the present invention;

FIG. 6 illustrates a flow chart for intercepted triggering of execution of internet services according to a further embodiment of the present invention;

FIG. 7 is a flow chart illustrating a method for intercepted triggering of execution of internet services according to an embodiment of the present invention;

FIG. 8 represent a flow chart illustrating an example according to an embodiment of the present invention;

FIG. 9 represent a flow chart illustrating certain specific steps of intercepted triggering of execution of internet services according to an embodiment of the invention;

FIG. 10 represent a flow chart illustrating certain steps of intercepted triggering of execution of internet services according to an embodiment of the invention;

FIG. 11 represents a typical invocation of internet services;

FIG. 12 illustrates an interaction pattern according to the prior art.

### DETAILED DESCRIPTION OF THE INVENTION

In the following, several embodiments and examples of the present invention will be presented. As it will also be evident from the following explanation, the different embodiments can be differently combined according to the principle of the invention.

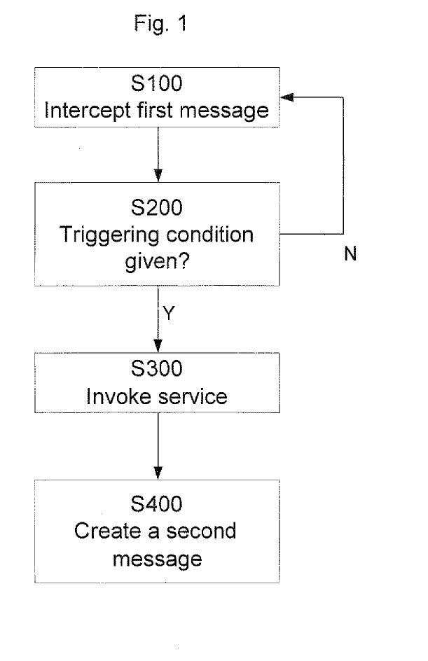

A first embodiment of the present invention will now be described with reference to FIG. 1 illustrating a flow chart of a method for dynamic execution of internet services.

An internet service is a software system designed to support machine to machine interaction over the network. An internet service is in fact a software component which allows a network device to access services provided by this software component residing on a different network device over a communications network to which both network devices are connected. In general we may say that an internet service is a software component that can be accessed over the internet. A type of internet services to which the present invention is applicable relates to software components providing services for a user. The user can be a user of a communication terminal connected to the internet. The communication terminal may be a mobile device, a PDA, a computer, a laptop or any other device capable of connecting to a communications network over any kind or wired or wireless interface.

An internet service may be implemented in any way as also explained above in the initial section relating to the background art.

Dynamic execution refers to the execution of additional or alternative services for the purpose of dynamically extending or modifying the functionality of web applications. Typically, internet services or web services are provided by a network device in response to a request from a requesting network device. Dynamic execution implies that, starting from an initially requested internet service, this requested service can be modified in order to provide enriched and enhanced results or information. The modification is made on the basis of the initial request for a certain internet service and/or other parameters as resulting for instance from a predetermined set of rules. The set of rules may indicate how a requested internet service is to be modified in order to extend its functionalities. Some examples of a dynamic execution of internet services will be provided later while describing a use case referred to as weather case. Therefore, according to an example, a first requested service can dynamically interact with other internet services to provide enhanced information. This interaction results from the combination and co-operation between the initially requested service and the further services which are involved on the basis of the initially requested internet service.

The method comprises a first step S100 of intercepting a first message sent from a source entity to a destination entity to obtain an intercepted message.

The intercepting consists in capturing packets(s) related to a message sent from a first network entity and directed to a second network entity and can be achieved by any means which is capable of handling such packet(s). Such means can for instance be represented by a router, a switch or a device placed on the communication path between two devices exchanging those packets. Furthermore, those means for capturing packets can be represented by a network entity (e.g. a plurality of distributed network devices or a network node) which may be placed on the path between the source entity or the destination entity or by a network entity to which the first message is forwarded by another network entity placed on the communication path over which the message to be intercepted is exchanged. As it will also be seen in more detail later, different means of interception can be provided, like for example: by sending the request to a predefined interception node; by using a dedicated proxy; by using for instance domain name resolution in order to identify a node capable of performing the interception; or a regular node within a network infrastructure which then intercepts all traffic and which could optionally apply filtering on certain messages of interests. The step of intercepting may optionally include a step of duplicating the original first message, though the duplication of said message is not strictly necessary since the same operations could be performed when starting on the message itself without making any copy thereof. As mentioned, the interception could be done on all packets, representing messages sent from a given source to a given destination, or only on a subset of all packets handled by an intercepting means in order to select among those packets only one or more desired messages from one or more source entities to one or more desired destination entities.

The first message in one example may be represented by a first (or initial) request for an internet service. In such a case, therefore, the first message may optionally be represented by a request from a user terminal to an internet web server for the provision of an internet service. This may be a request for the provision of information produced by the execution of a software component representing the requested internet service. The invention is however not limited to the case of a user terminal requesting a service from a server. In fact, the invention is equally applicable to the case wherein the request is from a first user terminal to another user terminal in order to provide to the first user terminal with information resulting from an internet service provided by the second user terminal. Similarly, the invention may also be applied to the case wherein the source entity and destination entity are both represented by two separate and distinct network nodes and wherein the first message is a request for internet services provided by the other network node. Also the case wherein the first node is a network node and the second node is a user terminal may be foreseen, wherein therefore the first message would represent a request from a network node to a user terminal providing internet services to the network node. In summary, the source entity can be any distributed system or any network node, or any user device like a mobile terminal, laptop or any other user terminal capable of connecting to a network. Similar considerations apply to the destination entity. The first message can be also represented by a message sent for interacting with an internet service: in other words, the first message is not necessarily an initial request for executing an internet service but may also be a generic message that shall interact with an internet service.

The step of intercepting S100 will therefore result in obtaining an intercepted message by one of the means above explained.

The method then foresees a step S200 of determining whether at least one triggering condition is given based on the intercepted message. The triggering condition is associated to the execution of at least one internet service. In other words, the method determines whether it is present at least a condition that represents or is associated to a trigger for executing at least one internet service. Thus, it is checked whether it is present or it exists a condition that would trigger the execution of at least one internet service. In one example, the internet service associated to the triggering condition is an internet service provided from an external network entity. The external network entity may be a network entity different or external from the entity or device that intercepts the message or that determines the presence of the triggering condition. The triggering condition expresses a condition that causes the execution of a software component, wherein this software component may be provided by the mentioned external network entity. The external internet service is therefore—according to an example—also distinct and separated from the initially requested internet service associated to the first message. When a triggering condition is not given, the method may optionally foresee that the step S100 is again performed as indicated in the figure. However, the processes S100 and S200 may run in parallel such that such return branch indicated in FIG. 1 is only optional. Also the remaining processes or steps of the method can be indifferently performed in parallel or sequentially depending on the situation.

The method then foresees a step S300 of invoking the at least one internet service if it is determined that at least one triggering condition is given. In case the first message, as seen above in one example, represents a first request for an internet service (wherein the request is issued e.g. by the source entity to a destination entity) then the internet service invoked when the triggering condition is given is—according to the same example—a different internet service from the internet service associated to the intercepted message. Therefore, according to this example, the presence of a triggering condition results in the invocation of an internet service associated to the triggering condition wherein such a triggered service is different from the internet service associated to the first intercepted message.

The method then foresees a step S400 of creating a second message based on the invoked internet service. It is noted that the triggering condition may refer to more than one internet services and that therefore the step of invoking may refer to invoking a plurality of internet services. Similarly, the step of creating may refer to creating a second message based on a plurality of invoked internet services.

Through the step S400 of creating a second message it is therefore possible to provide an enhanced service. In fact, the second message results from the execution of the software component associated to the invoked internet service and can therefore provide enriched or enhanced information inter-related to the first intercepted message. In other words, the present invention (as for instance embodied in the method of this embodiment) determines whether a condition exists that triggers the execution of an internet service. This condition is based on an intercepted message and the invocation of the triggered service results in the creation of an enhanced second message based on the result of the invoked internet service. Through the interrelation of those steps, it is thus possible to provide a second message which has enhanced information based on the response produced from the invoked internet service. The second message may be optionally based additionally on the first intercepted message, which is thus conveniently modified on the basis of the response from the invoked service. Details of examples of the usage of the second message or of its creation will be provided later in the description. At this stage, it suffices to say that, according to one example, the second message may represent a message which is sent back to the source entity thus providing the source entity with enriched and enhanced information. In another example, the second message is sent forward to the destination entity therefore providing the destination entity with enhanced information or with adapted information more suitable for the destination device.

According to a modification of the method of the first embodiment, a further optional step (non illustrated) may be provided of examining the content of the intercepted message to create an examination result. Examining or analyzing the content implies that the content of the intercepted message is analyzed in order to look for specific information. In one example explained in more detail in the following, the specific information represents a meaning of the content of the intercepted message. In one example, the step of examining comprises parsing the content of the intercepted message. Within the present invention, the terms “parsing the content of a message” are used to refer to analyzing the content of the same message (for instance by sequentially analyzing a word or a plurality of words or parts thereof as comprised in the message) in order to determine formation like the structure or the meaning associated to the content of the message. Analyzing the intercepted message may comprise scanning through or searching in the intercepted message; these operations are performed on a sequence of tokens of the message, wherein a token may represent a word, a plurality of words or parts thereof. The outcome of the step of examining or analyzing the content of the intercepted message is an examination result. As it will be seen in the following with reference to some examples, the examination result may be represented by one or more tokens (again, representing word(s) or parts thereof) which match certain conditions. In one non limiting example, when a parsed token coincides with a token or a word stored in a database (for instance a pre-annotated database of words or a corpus of training as sometimes referred in certain systems dealing with analysis of content of messages relating to human languages) then an examination result is produced, wherein the examination result may be represented by the word producing the match or by a predetermined code. The word or the predetermined code produced as examination result may then be associated to an internet service. According to such example, therefore, a parsed word (or more in general token) matching a condition may be directly associated to an internet service. An example of such optional implementation will be provided later with reference to the weather example or advertisement example.

According to this modification of the first embodiment, the step of determining that at least one triggering condition is given may optionally comprise determining that the trigger is given when the examination result satisfies predetermined conditions. As already mentioned above, in the example wherein the examining or analyzing the content of the intercepted message comprises parsing the same, when a match between a parsed word (or token) and a pre-stored word (or token) is found, then a triggering condition is determined. In other words, the modification of the first embodiment provides that a triggering condition may be determined when the result of the examination of analysis of the intercepted message satisfies certain predetermined conditions.

In another example further detailed in the following, the step of examining may comprise performing a semantic analysis of the content of the intercepted message in order for instance to search (e.g. through parsing the message) for keywords matching with those stored in a database or for finding pattern of words (or tokens) matching with predetermined rules or pre-stored patterns. Such matching may be associated to a meaning of the content of the intercepted message. In other words, a triggering condition is generated when a given meaning is detected on the basis of a semantic analysis of the content of the intercepted message, wherein the content may represent human language (as for instance provided by a user of the first network entity sending the intercepted message). According to a further example, the step of examining the content may comprise parsing the content and checking whether parsed words (or tokens) follow or satisfy predetermined rules. In other words, the semantic analysis or semantic examination may lead to an examination result (and ultimately to a triggering condition for an internet service) when a given parsed token(s) matches with predefined token (or tokens or combinations thereof) or when the parsed tokens satisfy predetermined conditions (e.g. relative distance between certain particular tokens stored in a database according to rules defined in a database).

In the present modification of the first embodiment, the step of determining that at least one triggering condition is given optionally comprises determining that the trigger is given when the examination result satisfies predetermined conditions. With reference to the example wherein the step of examining comprises parsing the content of the message, a trigger is given when for instance the parsed words (or tokens) satisfy the predetermined condition consisting in that said words (or tokens) correspond to entries in a data base. The entries in a database may represent stored tokens and/or rules among stored tokens (like e.g. distance among tokens or other inter-relationships amongst them). In one example, the mentioned predetermined conditions are included in policies stored in a policy database. Policies may represent a set of rules or scripts, as it will also be explained in more detail in the following, according to which the step of examining or analyzing shall be performed; and/or according to which each examination result is to be produced and/or according to which a trigger condition is to be generated according to whether the examination result satisfies predetermined conditions comprised in the policy. In one example, a rule comprised in a policy may be represented by the examination result—for instance the parsed tokens produced by the examination or analysis of a message—satisfying the condition that the parsed tokens corresponds to tokens stored in a database.

The first modification of the first embodiment above discussed may optionally foresee that the step of examining the content of the intercepted message may comprise examining according to predetermined semantic rules.

The above mentioned semantic rules may express a correlation between content of said intercepted message and internet services. Semantic rules comprise rules that allow analyzing the content of a message, wherein this content represents or is derived from human language, in order to determine a meaning that can be associated to the content of the message. Several techniques may be implemented, like for instance parsing the message to obtain tokens i.e. word, words, parts thereof or combinations thereof) matching with tokens stored in a given data base. Systems for instance based on a corpus of training may also be implemented as long as they allow associating a meaning to the content of a message. By examining according to predetermined semantic rules it is possible then to express a correlation between the content of the intercepted message and internet services. For instance, when examining according to the semantic rules, a result is produced representing a meaning associated to the content of the intercepted message; thus, it is possible to correlate that meaning to an internet service. Consequently, such internet service may provide information related to the meaning of the intercepted message as examined. Reference is also made to the examples illustrated in the following, wherein by analyzing the content of an intercepted message, the intention of a user can be detected (see for instance the weather example, wherein the user intention of travelling to a certain place can be determined). This intention as extracted from the meaning can then be associated to an internet service. The invocation of the internet service would produce a result consisting in providing enhanced information related to the content of the intercepted message. The predetermined semantic rules may optionally be preselected depending on a preliminary examination or analysis of the intercepted message. For instance the intercepted message may be subject to a preliminary analysis according to which the content of the intercepted message is parsed to search for words (or tokens) matching with predetermined keywords. Upon said match, a given policy may be selected which would then define a set of rules according to which a further or a more detailed analysis can be performed. As it will be seen with reference to the weather example, in a first preliminary examination an analysis may be performed for searching for the word relating to travelling. Upon detecting such a match, a policy related to weather may be selected. Such a policy may further define detailed rules for further examining the message. For instance, the detailed rules may provide that the intercepted message shall be examined to determine the destination of the travel in order to invoke internet service relating to the weather in that location. The same set of detailed rules may further provide that other internet services may be provided depending on other rules or results of the invoked weather service.

The method of the further embodiment or its modification may further and optionally foresee that the predetermined conditions are selected on the basis of the examination result. More in detail, the examination result may be used to indicate which predetermined conditions shall be selected, for instance as comprised in a policy selected according to a preliminary examination on the intercepted packet. A preliminary examination may for instance foresee the analysis of the header of the packets carrying the first message in order to look e.g. for destination addresses or source addresses which may then be used for selecting an appropriate policy and corresponding predetermined conditions. In one example the destination address of the first message may be analyzed in order to determine which policy to retrieve. Such retrieved policy may then comprise predetermined conditions that are used by the method in order to generate the triggering condition.

In an optional further implementation of the method according to the first embodiment, the second message may be sent to the source entity. Therefore, in such a case a first message may trigger execution of external internet services, which would produce a result on the basis of which a second message is generated. The second message is then sent back to the source entity thus providing the source entity with enhanced information related to the first message. When the first message comprises an initial request for an internet service from a destination device, the source entity may receive in response the second message comprising enhanced information related to the initial request. An example of such an embodiment will be described later with reference to the weather example.

According to a further optional implementation of the method according to the first embodiment, the second message may be sent to the destination entity. Thus, the first message may trigger the execution of the internet services, which will generate a response on the basis of which a second message is forwarded to the destination entity. The destination entity will therefore receive a message comprising enhanced or more detailed information that could be used for providing enhanced applications or services on the destination entity. Examples will be provided later of the application of such optional implementation with reference to the case referred as advertisement user case or conversion of vocabulary in applications like chatting.

According to a further optional implementation, the second message may be additional created based on the first message. In other words, the second message may be created optionally on the basis of both the invoked internet service or more specifically on the basis of a result from the invoked internet service, and on the basis of the first message. Therefore, such second message would conveniently comprise information as derived from the initial first message and from the invoked internet service thus providing enhanced and interrelated information.

The method of the second embodiment and its variation can be implemented in hardware, software or any suitable combinations thereof. Moreover, it can be implemented in one single device or in a plurality of devices, wherein the different functions are conveniently provided. For instance, the steps or the above methods or only some of them can be conveniently implemented in any of the network entities or system described in the following with reference to further embodiments. Moreover, the above steps can be conveniently distributed in the network entities described below. In the following, the same concepts and considerations made above still apply. Thus, these will not be repeated but reference is made instead to the above.

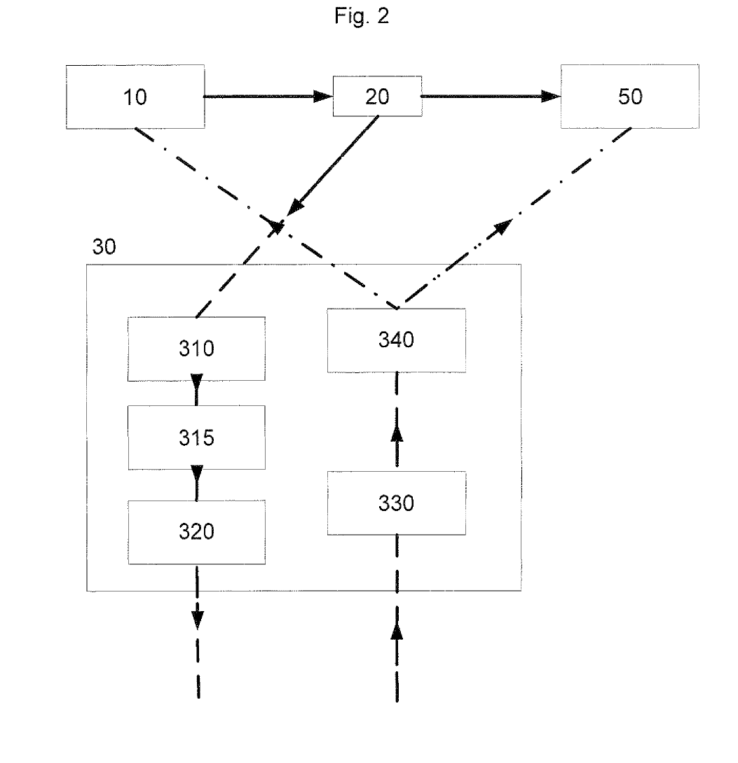

A network entity for dynamic triggering of internet services according to a second embodiment of the present invention will now be described with reference to FIG. 2. The network entity 30 comprises a message receiver 310, an examining unit 315 and a trigger entity 320. Optionally, as explained also in the following, the network entity 30 may further comprise a controller entity 330 and a message creator entity 340.

The message receiver entity 310 is adapted to receive an intercepted message corresponding to a first message sent from a source entity 10 to a destination entity 50.

The intercepted message may be sent, as depicted in FIG. 2, from a dedicated node placed on the path between the source entity 10 and the destination entity 50—though this is not strictly necessary. In fact, according to another example, the network entity 30 itself may be placed on the communication path between the source 10 and destination 50 such that it would be able to receive and optionally filter all packets from the source entity 10 to the destination entity 50. In fact, as described above and as also explained in more detail in the following, different means for intercepting messages can be foreseen. With reference to the network entity 30, what is relevant is that the message receiver 310 is adapted to receive intercepted messages regardless of how the messages are intercepted.

The examining unit 315 is adapted to examine the content of the intercepted message to create an examination result. In other words, the intercepted message received from the receiving entity 310 is forwarded to the examining unit 315; therein its content is examined. The output of the examining unit 315 corresponds to the examination result.

The trigger entity 320 is adapted to generate at least one triggering condition associated to the execution of at least one internet service. For what concerns the examination result, the triggering condition, the internet service associated to the triggering condition, etc. . . . similar considerations apply here as made with respect to the first embodiment, to which reference is made.

The trigger entity 320 is further capable of generating at least one triggering condition when the examination result satisfies predetermined conditions. Also here, similar considerations apply as made in the first embodiment with reference to the generation of the triggering condition when the examination results satisfies predetermined conditions. Consequently, the network entity 30 according to the second embodiment is capable of deciding and correspondingly generating triggering conditions associated to the execution or invocation of an external internet service on the basis of an analysis of an intercepted message. According to an example, as described with reference to the first embodiment and which also applies to the second embodiment, the examination may be directed at finding word(s) (or tokens) that could be associated to a meaning of the intercepted message; in this way, it is possible to determine whether the found words (or tokens) match predetermined conditions. The predetermined conditions may in one example be represented by the found words (tokens) matching with words (tokens) or combinations thereof as stored in a dedicated database. Parsing of the intercepted message is also one example for implementing the examination performed by the network entity 30.

As already mentioned, the network entity 30 of the second embodiment may further and optionally comprise a controller entity 330 for handling at least one reply message corresponding to the one or more responses generated by the one or more internet services associated to the triggering condition. It is noted that the network entity 30 may either directly receive the response from the entity providing the invoked internet service or it may receive a message corresponding to the response, in which case the actual response may be received from another network entity and then forwarded to the network entity 30.

The network entity 30 may optionally further comprise a message creator entity 340 for creating a second message on the basis of the one or more reply messages generated by the one or more internet services corresponding to the triggering condition.

In other words, the network entity 30 may generate triggering conditions resulting in the invocation of one or more internet services. The responses of said invoked internet services may further optionally be detected by the same network device 30 which could then use those replies to generate a second message. The obtained second message comprises enhanced information derived from internet services related to the initial message intercepted and received by the network entity 30. The advantage lies in the creation of an improved way of assembling information when starting from an initial intercepted message sent from a first network entity and intended for a destination entity.

Furthermore, the examining unit 315 of the network entity 30 may be further and optionally adapted to examine the content of the intercepted message according to predetermined semantic rules expressing a correlation between the content of the intercepted message and internet services. In other words, the examining unit may analyze the content of the intercepted message according to semantic rules, implying that the message can be searched or parsed in order to determine a meaning associated to the intercepted message. In other words, the semantic rules provide a set of rules for determining a meaning corresponding to the content of the intercepted message. On the basis of the analysis according to the semantic rules, it is then possible to correlate the content of the intercepted message with internet services. In other words, internet services as for instance provided by an external network device or provider can be correlated or associated to the intercepted message according to the content of the same intercepted message (e.g. according to the meaning associated to the intercepted message).

The trigger entity of the network device 30 may further and optionally be further adapted to invoke one or more internet services upon detection of the triggering condition. This is optional since in fact in another example the invocation of the internet service may be performed by another network entity or device which receives the triggering condition from the trigger entity 320.

Moreover, the controller entity 330 of the network entity 30 may further and optionally be adapted to receive one or more responses generated by the one or more internet services which have been invoked by the trigger entity 320 or by the external network entity receiving the triggering condition from the trigger entity 320. Thus, in one non limiting example, the network entity 30 itself may determine the triggering condition, invoke the one or more internet services corresponding to the triggering condition and receive the one or more corresponding responses. As explained above, each of the functions of invoking internet services and receiving corresponding responses may be implemented optionally in the network entity 30. As evident from the above, each of said functions or both of them may be also equivalently implemented in a separate and distinct network entity.

The controller entity 330 may optionally be further adapted to receive from another network entity the one or more reply messages corresponding to the one or more responses of the internet services that were invoked in accordance with the triggering condition. Therefore, as already mentioned above, in another implementation of the invention, the controller entity 330 may receive the message not directly from the network entity providing the invoked internet services but indirectly from another network entity, which would then forward the actual response or a message corresponding to the actual response to the network entity 30.

The examination unit 315 may optionally be further adapted to create the examination result on the basis of a set of rules received from a policy entity. In a further optional implementation, the policy entity may also send the predetermined conditions to the network entity 30. Furthermore, both the set of rules and the predetermined conditions can be part of a policy as provided by a policy entity. Reference is also made to the considerations made in the first embodiment for the policies, the predetermined conditions etc. . . . that equally applies to the present second embodiment.

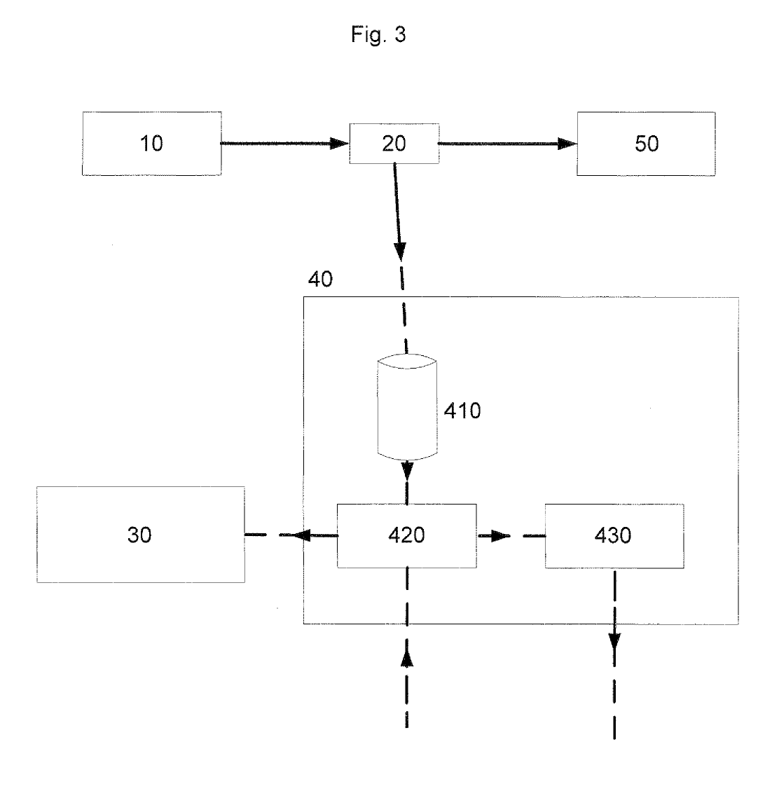

A network entity 40 for dynamic invocation of Internet services according to a third embodiment of the present invention will now be described with reference to FIG. 3. The network entity 40 comprises a data base 410 for storing policies related to execution of services, a controller entity 420 and an invoker entity 430. The controller entity 420 retrieves from the data base 410 a policy corresponding to a triggering condition received from another network entity. The triggering condition is determined on the basis of an intercepted message.

The invoker entity 430 is adapted to invoke an internet service corresponding to the mentioned policy. Furthermore, the controller entity 420 is adapted to receive a response from the internet service invoked and for forwarding a reply message corresponding to the response from the invoked internet service to the further network element which sent the triggering condition.

Considerations made in the above embodiments apply here as for instance with reference to the term dynamic invocation of internet services, intercepted message, triggering condition etc. . . . The policy retrieved from the database corresponds to a triggering condition that is determined on the basis of the intercepted message. Based on the retrieved policy it can be determined which internet services are to be invoked such that the response from the invoked internet services is used for generating a reply message (corresponding to the response or based on the response) to the network element which sent the triggering condition. Therefore, according to the present embodiment, the network entity 40 receives a triggering condition generated on the basis of the intercepted message. The triggering condition then causes the controller entity to retrieve a policy corresponding to the triggering condition. On the basis of the retrieved policy it is determined which internet service to invoke. The determined internet service is consequently invoked and its result is used to generate a reply message sent back to the further network element which initially sent the triggering condition. In one further optional implementation, the policy retrieved from the database may comprise a set of rules according to which it can be determined which internet service to invoke. For instance, a set of rules may indicate which type of examination or analysis has to be performed on the intercepted message in order to determine the internet service to be invoked. The examination or analysis of the intercepted message may be performed on the same node or in another implementation on a separate node.

In one example of implementing the network entity 40 according to the present embodiment, it can be foreseen that the intercepted message is subject to a first preliminary analysis according to which the mentioned triggering condition is determined. The triggering condition then causes the controller entity to retrieve a policy from a database. According to the retrieved policy, in a further optional feature, the intercepted message may be further analyzed on the basis of a set of rules comprised in the retrieved policy in order to determine which internet service to invoke. The reply from the invoked internet service is then used to generate the reply message above mentioned which is sent to a further network entity in order to provide it with enhanced information. The preliminary and detailed examination (or analysis) made on the intercepted packet can be performed in several ways as described above with reference to the other embodiments.

A system for dynamic execution of internet services according to a fourth embodiment of the present invention will now be described with reference to FIG. 4. FIG. 4 comprises a source entity 10 and a destination entity 50. In one example, a first message is sent from the source entity 10 to the destination entity 50. In one non limiting example the first message may represent an initial request by the first network entity 10 for an internet service provided by the destination entity 50.

The system according to the present embodiment comprises an intercepting entity 620 for intercepting the mentioned first message sent from the source entity 10 to the destination entity 50 in order to obtain an intercepted message. The controlling entity 630 comprised in the system determines whether at least one triggering condition is given on the basis of the intercepted message. The triggering condition is associated to the execution of one or more internet services. The system then comprises an invoking entity 640 for invoking the one or more mentioned internet services which are associated to the triggering condition, if it is determined that the mentioned triggering condition is given. In other words, upon determining that the triggering condition is present, a corresponding internet service is invoked. The message creator 650 comprised in the system then creates a second message on the basis of the one or more invoked internet services.

The entities 620 to 650 can be implemented in one single network device; in another embodiment each of them can be implemented in a separate and distinct network device; in a further implementation they can be distributed in two or more network devices as more convenient according to circumstances.

The system according to the present embodiment may further and optionally comprise a message transmitter 660 for sending the second message to the source entity 10 and/or to the destination entity 50. Therefore, the second message created on the basis of the response from the invoked internet service can be sent back—in one embodiment—to the source entity 10, as later described with reference to the weather case, or sent—according to another embodiment—to the destination entity 50 as described in one example relating to the adaptation or conversion of content comprised in the initial message sent from the source entity 10 to the destination entity 50. In a further embodiment, the second created message can be sent to both the source entity and the destination entity in order to provide both with enhanced information.

The controlling entity 630 may optionally be further adapted to examine the content of the intercepted message to create an examination result. With this respect, similar considerations apply here as made above with reference to the intercepted message and the examination result. The controlling entity 630 may optionally further determine that the trigger is given when the examination result satisfies predetermined conditions. Also here, considerations made above with reference to the predetermined conditions (as well as its relationship with the policy etc. . . . ) apply.

Therefore, the invention can be conveniently applied in a system as depicted in FIG. 4 or as described in the present embodiment, wherein the several parts of the system can be conveniently implemented in one single device or conveniently distributed among a plurality of network devices.

According to a further embodiment of the present invention, it is provided a computer program for performing dynamic execution of internet services. The computer program comprises instructions which are configured, when executed on a programmable system, to cause the programmable system to carry out for instance the steps as depicted in the flow chart of FIG. 1 or as described in the above first embodiment or its modifications. A computer system, not depicted in the figures, typically comprises a processor for executing the mentioned instructions, a memory (like a hard disk, or based on semiconductor, volatile or not, etc. . . . ) for storing those instructions and possibly further input and/or output means for interacting with a user or with data devices as known in the art. An example of a programmable system is represented by a computer or by any computing machine as known in the art.

In the following, further embodiments and/or examples will be provided illustrating how the concept of the invention or the above embodiments and modifications thereof can be put into practice. Such examples are therefore given for illustrating how the invention can be put into practice and shall not be considered as limiting the principle of the invention.

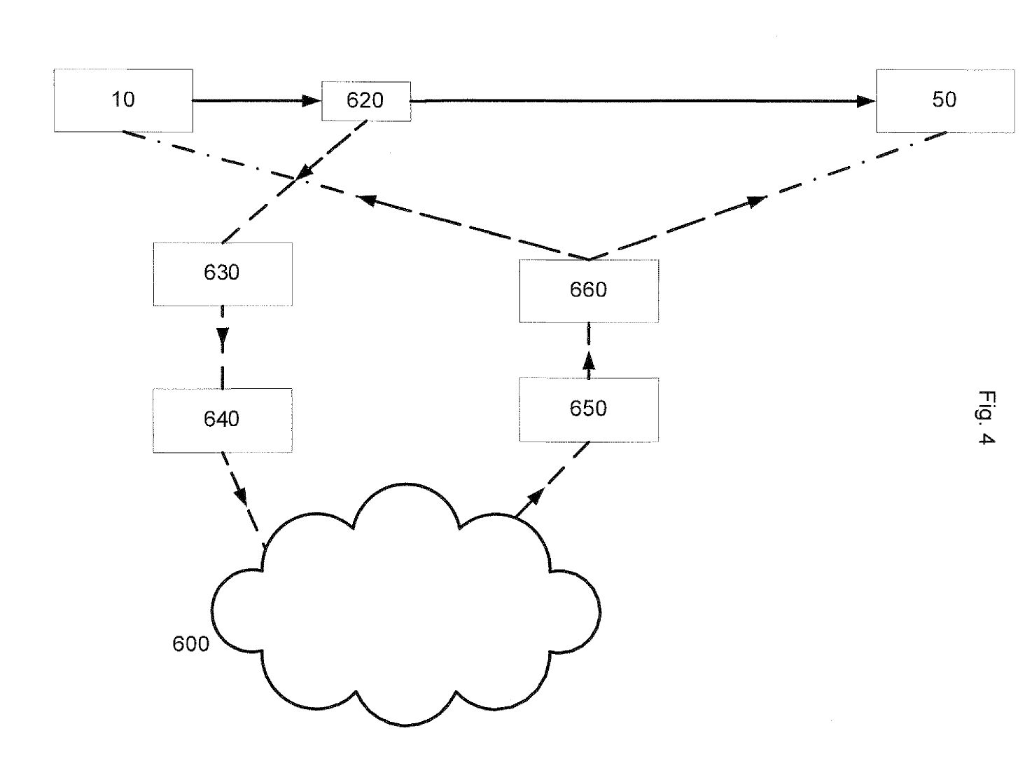

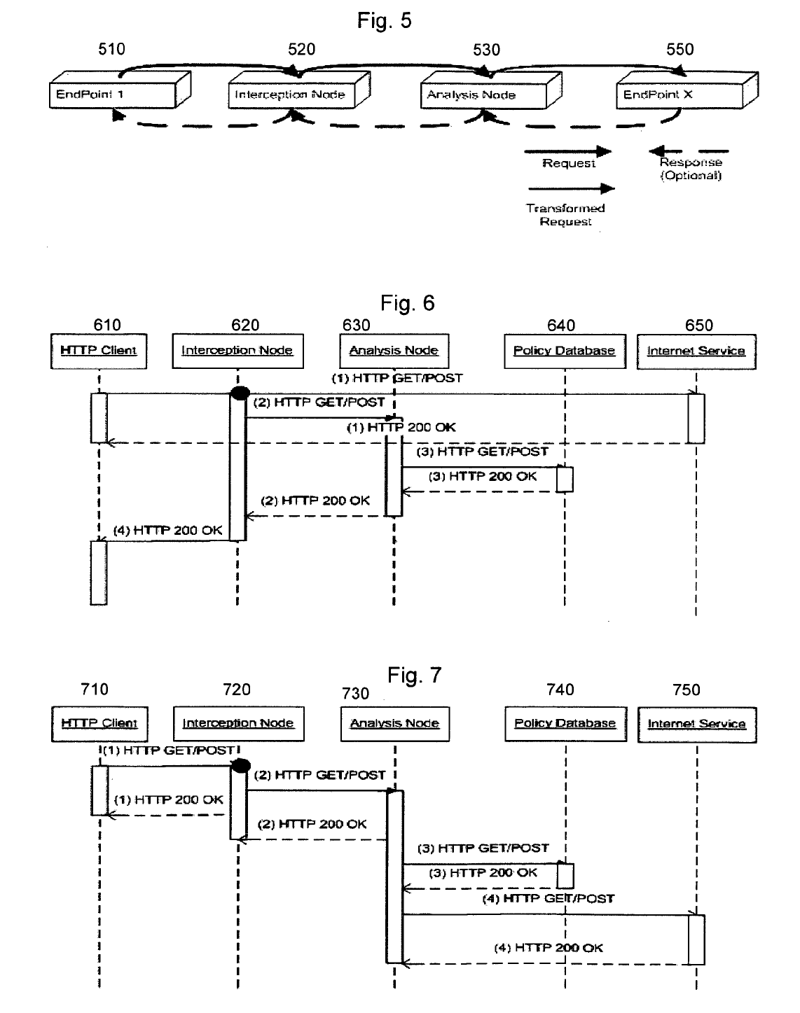

As already discussed above, a web application is considered static by nature once deployed. This invention implements a method for triggering the execution of new additional or alternative services for the purpose of dynamically extending or modifying the functionality of a web application without requiring changes in its implementation. FIG. 5 illustrates a system and devices for implementing the invention according to one example. End point 1 (510) represents an example of a source entity sending a first message. The first message may be a first request for an initial internet service, which could be provided by a node not shown (it can also be foreseen that the initial internet service is to be provided by the end point X 550, in which case end point X 550 may represent an example of the destination entity discussed above). The interception node 520 represents an example of the means for intercepting messages as described earlier, while the analysis node 530 represents an example of the network entity 30 described above. As illustrated in FIG. 5, the end point 1 (510) issues a first message comprising a request for an internet service to a destination entity. The message is intercepted by the interception node 520, which forward it (or optionally a copy thereof) to the analysis node 530. The analysis node 530 performs an analysis corresponding to the examination above discussed. Thus, the analysis can be performed as above mentioned or as also described in more detail in the following. The analysis node will produce a result, according to which a further internet service is invoked. The further internet service may be provided by the end point X or by a different node not illustrated or a combination thereof. It is noted that end point X may provide both the initial and the further internet services in one example. In other embodiments, those services are provided by distinct and separated nodes. In case the further invoked internet service is provided by the end point 550, then a response will be produced by the execution of the further internet service by the end point 550. The response may be directly sent to the end point 1 (not illustrated). Alternatively, the response may be sent to the analysis node 530 that will take care of forwarding it or assembling it in a new message also on the basis of the initial message. The new message may then be sent to the end point 510 and/or to the destination entity (wherein the destination entity may be a different node not shown or the same end point X 550).

According to an illustrative example of the functioning of the invention, it is provided a method (corresponding devices and system are directly derivable) for analyzing and intercepting requests (e.g. via an interception proxy) towards a web application before they reach the service provider and triggering new requests for other additional or alternative services. Such method may be performed by the devices and system of FIG. 5. The service provider may be represented by the destination entity described above. The process of interception is applied in messages being transmitted from the client (e.g. the source entity) to the server (e.g. the destination entity) and from the server to the client. The proposed approach can be applied to session-based protocols or to request/response protocols. The request being intercepted is transmitted by means of a specific protocol which mandates a format for its structure and content. Possible embodiments of such protocols could be XMPP, HTTP or SIP and possible payload could be protocols pr languages used by SOAP Web Services, MSN, Twitter, IRC or any other type of communication service. The interception node will promote to the analysis phase all the messages that target the web application to be enhanced. An example of such messages could be an HTTP GET Request for a specific resource or an HTTP POST Request with SOAP payload for the invocation of a WSDL service.

The consecutive phase after the process of interception is that of analysis which occurs in what is referred in the context of an embodiment of this invention, as the analysis node. The analysis node may be a particular implementation of the network entity 30. The analysis node is the node that receives the message propagated by the interception node and it deals with the process of analyzing that message and deciding what enhancements should be implemented.

Possible results of the analysis could be the execution of:
Transformation of the signal/message mandated by a policy
Execution of a workflow or other type of composite service that entails execution of a number of additional services.

The above possible executions represent two examples of types of internet service that can be invoked.

This implies that vocabularies of interaction patterns described earlier, no longer are isolated within the confines of the provider that is offering a specific service. This node can analyze messages from web applications and can apply the same vocabulary for all intercepted messages (e.g. in the example wherein the second message produced as a result of the invoked internet service is forwarded to the destination entity). One simple example of this could be that two text messages containing a certain letter combination will result in the same type of emoticon regardless if the message was sent using Microsoft Messenger or Twitter. Once these messages are intercepted by the system, transformation will be triggered in the analysis node and the messages will be modified accordingly to present the smiley. In this case, the examination described above will determine the type of applications or internet services to which the initial message was sent; then, a certain policy is selected, which would indicate how to make the conversion for instance by invoking an external internet service; such internet service may provide in response the desired converted message.

Following the analysis, a process (or more of the following) is performed based on the decision/transformation that was applied to the original message:
one or many new messages (e.g. service invocations) are generated the original message does not necessarily need to be propagated
the new messages are propagated either to the original endpoint or to different nodes.

In the following, further examples will be provided to clarify the invention and further aspects thereof.

The Interception node is responsible for intercepting messages from client to server or from server to client and dispatching these messages to the Analysis node. Even though the interception node is situated within a network in a position that allows for the interception of all messages that pass through it, this specific node is interested only in messages that aim for triggering an internet service. Such messages can be distinguished by the information defined within their headers and payload.

As an example, in the HTTP protocol, HTTP request methods of type GET or POST are semantically directed towards the invocation of an internet service. More specifically, HTTP GET requests are directed towards invocation of REST full services, while HTTP POST requests with SOAP payload are directed towards the invocation of WSDL services.

Possible means of interception can be the following, by way of example:

a. Directly, by sending the request to the pre-defined interception node, or

b. by using a dedicated proxy or,

c. in a transparent fashion, by using domain name resolution in order to identify such a node.

d. as a regular node within a network infrastructure, acting in promiscuous mode, thus intercepting all traffic.

The Analysis Node is a second element comprised in an embodiment of the proposed invention and it is assigned with the task of analyzing the internet service invocation messages, it receives from the Interception node. The analysis node is an example of the network entity described above (though further examples may evidently be provided). In order for this to be achieved, the Analysis Node can employ policy driven approaches, or workflows or service composition techniques. In the following, a specific example will be provided on how the analysis node operates.

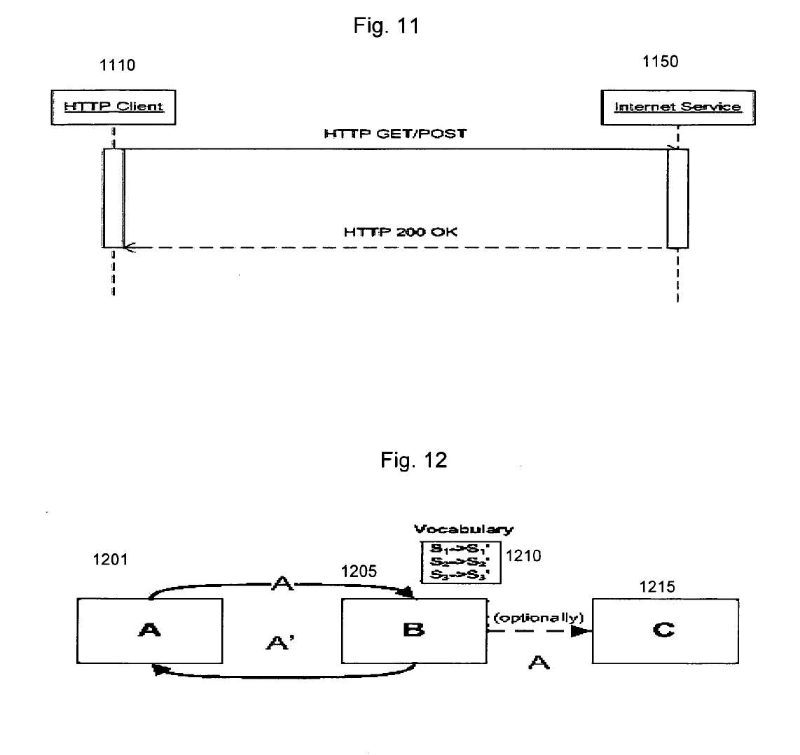

Before discussing further details about the invocation of internet services, a brief discussion will now be made about the basic invocation of an Internet Service. In the current state of the art, invocation of an internet services follows the pattern portrayed in FIG. 11.

As shown in FIG. 11, an HTTP client 1110 sends an HTTP request to an Internet Service 1150. This HTTP request in most common cases is either GET or POST and depending on the type of the HTTP service the payload is formulated accordingly. For instance, when invoking a SOAP based HTTP service, the payload is a SOAP envelope that is targeted towards a specific function that is exposed from that Internet Service.

A basic SOAP envelope can be the following, by way of example:

```
POST /InStock HTTP/1.1
Host: www.example.org
Content-Type: application/soap+xml; charset=utf-8
Content-Length: nnn
<?xml version=″1.0″?>
<soap:Envelope
xmlns:soap=″http://www.w3.org/2001/12/soap-envelope″
soap:encodingStyle=″http: //www.w3.org/2001/12/soap-encoding″>
<soap:Body xmlns:m=″http: //www.example.org/stock″>
  <m:GetStockPrice>
    <m:StockName>IBM</m:StockName>
  </m:GetStockPrice>
</soap:Body>
</soap:Envelope>
```

Such a request is used in order to retrieve the StockPrice of a specific Stock, in this case IBM's.

In this case the response would be:

```
HTTP/1.1 200 OK
Content-Type: application/soap+xml; charset=utf-8
Content-Length: nnn
<?xml version=″1.0″?>
<soap:Envelope
xmlns:soap=″http: //www.w3.org/2001/12/soap-envelope″
soap:encodingStyle=″http: //www.w3.org/2001/12/soap-encoding″>
<soap:Body xmlns:m=″http: //www.example.org/stock″>
  <m:GetStockPriceResponse>
    <m:Price>34.5</m:Price>
  </m:GetStockPriceResponse>
</soap:Body>
</soap:Envelope>
In case of a RESTFul service an example of an HTTP Request is
the following:
GET
http: //ws.audioscrobbler.com/2.0/?method=user.getrecenttracks
&user=rj&api_key=xxxxxxxxxxxxxxx HTTP 1.1
Host: ws.audioscrobbler.com
Content-Length: 0
```

In this case, instead of a payload, the body of an HTTP request, we are using the HTTP URI and the query string to specify the parameters of our request—in this specific case the retrieval of a user's recent tracks from “last fm”. This step of the present example refers to the invocation of an internet service provided by “Last.fm”, which allows a user to review the recent tracks listened by a user [see e.g. http://www.last.fm/api/show?service=278]. In this example it can be seen that the parameters that configure this invocation are not found in the payload (according to an example of invoking a service)) but in the query string of the HTTP request, which is a further available option for invoking external internet services. This provides a non limiting example of how an “invocation of an internet service” can be performed. Further possibilities for invoking a service are however available as immediate to the reader.

In this case the HTTP response would be

```
GET 200 OK
Host: ws.audioscrobbler.com
<recenttracks user=″RJ″ page=″1″ perPage=″10″
totalPages=″3019″>
  <track nowplaying=″true″>
    <artist mbid=″2f9ecbed-27be-40e6-abca-
6de49d50299e″>Aretha Franklin</artist>
    <name>Sisters Are Doing It For Themselves</name>
    <mbid/>
    <album mbid=″ ″/>
<url>www.last.fm/music/Aretha+Franklin/_/Sisters+Are+Doing+It
+For+Themselves</url>
    <date uts=″1213031819″>9 Jun 2008, 17:16</date>
    <streamable>1</streamable>
  </track>
  . . .
</recenttracks>
```

After having briefly discussed the above, description will now be given of Intercepted Triggering of Execution of Internet Service according to an example clarifying how the invention can be implemented. Reference will be made to FIG. 6.

1. As described in the previous paragraph, invocation of an Internet service basically occurs when sending an HTTP Request from an HTTP client 610 to an Internet Service 650. In the context of this example it is provided an extension on top of this basic pattern that includes an Interception Node 620, an Analysis Node 630 (representing an example of the network entity 30) and a Policy Database 640 (representing an example of the network entity 40). It is noted that the systems of FIG. 5, 6 or 7 represent examples of implementing the method, devices and system depicted in FIGS. 1 to 4. As depicted in FIG. 6, an (1) HTTP GET/POST request is sent from the HTTP Client to the Internet Service and the Internet Service replies to this request with an HTTP 200 OK and the corresponding payload that contains the response.

2. When the (1) HTTP/GET POST request is sent, it is intercepted by the Interception Node (e.g. either by traversing that node as a proxy or transparently using the Ethernet promiscuous mode). The interception node would make a clone of this HTTP request, a copy, which is identical in every way to the original request (exactly the same headers and the same payload). The copy is not essential and is applied to this example for convenience only. The cloned (2) HTTP GET/POST request will be propagated afterwards to the analysis node.

3. When the analysis node receives the (2) HTTP GET/POST it goes through the headers/payload of this cloned request and tries to find out which policy to look up in order to analyze this request and create a decision out of it (see also the preliminary examination described above, of which this step represents an example). With regards to policies, a policy database is used as a repository of such and an (3) HTTP GET/POST for the retrieval of a specific policy is sent from the analysis node, to the Policy database in order to retrieve the corresponding policy. A policy can either be implemented as a vertical application, or as a workflow by means of BPEL engine or as a composition by means of a composition engine. The analysis node, using the cloned (2) HTTP/GET POST and the policy found in the policy database (found in (3) HTTP 200 OK) would analyze the content of (2) and decide how to formulate the content of the new message that would be sent back to the HTTP Client. Such stage or step represents an example of the step of examining described in the first embodiment or to the corresponding features of the entities of FIGS. 2 to 4.

4. The new content as defined by the analysis node is placed inside the (2) HTTP 200 OK response and is sent back to the interception node. The interception node then will propagate back this response to the HTTP Client with (4) HTTP 200 OK (according to one example).

The above references are those of FIG. 6.

In the following, another example will be provided with reference to FIG. 7 for further clarifying how the invention can be put into practice. Therein, nodes 710-750 are similar to nodes 610-650 illustrated in FIG. 6. In the following, their interaction will be explained especially with reference to the differences with the example depicted in FIG. 6.

1. According to this example, the original HTTP request is not allowed to reach the Internet Service 750 immediately but first gets transformed and then its new version is transmitted to the original endpoint 710. As depicted in FIG. 7, an (1) HTTP GET/POST request is sent from the HTTP Client to the Internet Service.

2. When the (1) HTTP/GET POST request is sent, it is intercepted by the Interception Node 720 (either by traversing that node as a proxy or transparently using the Ethernet promiscuous mode). The interception node 720 may (optionally) make a clone of this HTTP request, a copy, which is identical in every way to the original request (exactly the same headers and the same payload). The cloned (2) HTTP GET/POST request will be propagated afterwards to the analysis node 730 (representing an example of the network entity 30 described above; however, the described functionalities may be differently combined as described with reference to the network entity 40). The original request (1) will stop its journey here and the interception node 720 will get back to the client with a (2) 2000K.

3. When the analysis node 730 receives the (2) HTTP GET/POST it goes through the headers/payload of this cloned request and tries to find out which policy to look up in order to analyze this request and create a decision out of it (this represents an example of performing a preliminary analysis to select a policy). With regards to policies, a policy database is used a repository of such and an (3) HTTP GET/POST for the retrieval of a specific policy is sent from the analysis node, to the Policy database in order to retrieve the corresponding policy. A policy can either be implemented as a vertical application, or as a workflow by means of BPEL engine or as a composition by means of a composition engine. The analysis node, using the cloned (2) HTTP/GET POST and the policy found in the policy database (found in (3) HTTP 200 OK) would analyze the content of (2) and decide how to formulate the content of the new message that would be sent back to the HTTP Client.

4. The new content as defined by the analysis node 720, is placed inside the (4) HTTP GET/POST request and is sent to the Internet service. In such a case, the internet service 750 is provided with modified (enriched or enhanced) information that would allow the same internet service to produce further enriched or enhanced information as a result of its execution.

In the following, a specific use-case is described in order to illustrate how the analysis node (being an example of the network entity 30) functions according to an example.

The specific use case, we are using here as an example and that we call as “weather case”, is about sending messages to twitter. More specifically, the example deals with intercepting the invocation of the Twitter service that occurs when a user updates her status for instance by means of an HTTP POST message. This HTTP POST message reaches twitter; according to this example, it is generated a second response to this request that offers additional information to that user.

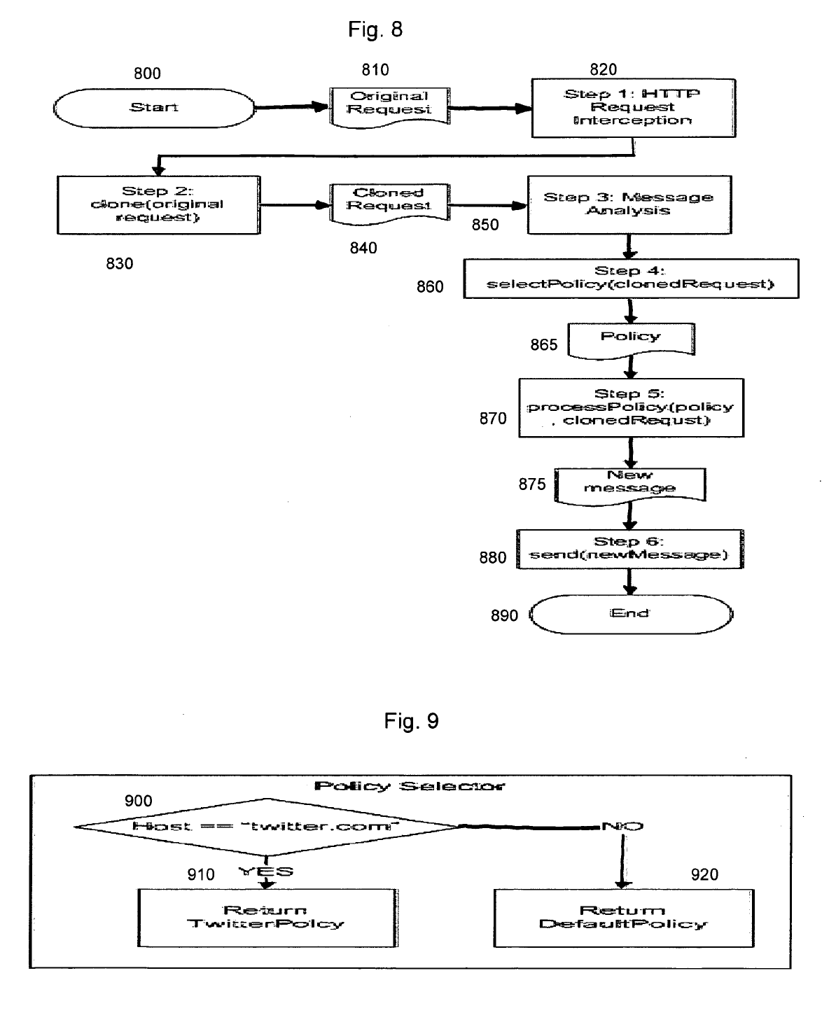

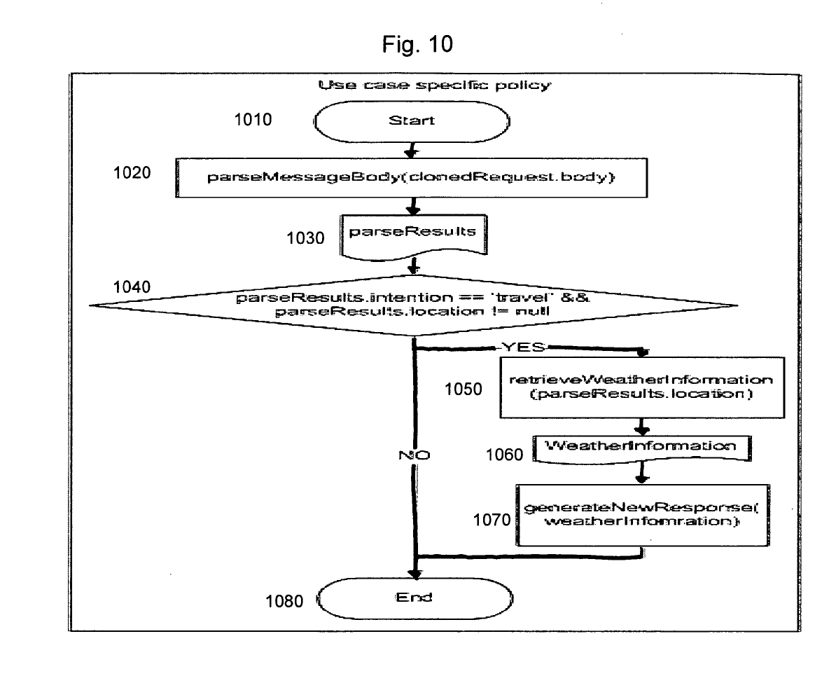

The use case is described with reference to the flow chart of FIG. 8:

1. Step 1: The HTTP request (representing an example of the first message sent from the source entity to the destination entity) is intercepted by the interception Node.

2. Step 2: The interception node creates a clone of this request (again, the copy is not strictly necessary). The clone contains the exact information as the original request. In this specific instance the original request contains the following information by way of example:

HTTP POST http: //twitter.com/statuses/update.xml HTTP/1.1
Host: twitter.com
User-Agent: Mozilla/4.0
Content-Length: nnn
Content-Type: text/xml
<?xml version=″1.0″ encoding=″UTF-8″?>
<status>
<created_at>Tue Apr 07 22:52:51 +0000 2009</created_at>
<id>1472669360</id>
<text>I'd like to travel to Stockholm, Sweden.</text>
<source> <a
href=″http: //www.tweetdeck.com/″>TweetDeck</a> </source>
. . . .
</status>

Evidently, according to the semantics of the clone process, the cloned message would contain the exact same information. Consecutively, the cloned message would be transmitted to the Analysis Node (e.g. to a network entity 30 or to a node 520, 620 or 720).

3. In Step 3, the analysis of the message begins. The analysis can be executed according to the step of examining above discussed.

4. In Step 4, the analysis node is going to decide which policy to use in order to analyze the cloned message (this represents an example of the preliminary analysis of examination). For this specific example we are going to be using a specific policy selector for this use case. However, this is just an example and different policy selectors could be applied in this step.

In this specific embodiment, the policy selector will go through the header found in the cloned request and it will select the Host field to check if this is a request that is going towards twitter.com. If that is the case, the TwitterPolicy would be returned, otherwise a DefaultPolicy may be used.

5. In Step 5, the clonedMessage will be processed using the policy that was returned by the PolicySelector.

6. If the policy that was returned is TwitterPolicy, then the following flow will be followed according to this example. As part of this process, this policy will use mostly the body of the clonedRegeust.

a. To be more specific, it will start to parse the message body in order to discover the user's intention and travel plans. In this context the message body is: “I'd like to travel to Stockholm, Sweden.” The parseMessageBody will discover that the verb travel is used along with the destination “Stockholm, Sweden”. This represents an example of the examining described above, according to which words (or tokens) are searched in a word matching predetermined conditions.

b. After the parseResults, the outcome of the previous checked, will be checked to determine whether or not the user wishes to travel and where she wishes to travel to. This is a further example of the examining according to which a meaning is associated on the basis of the parsed words matching with words or predefined rules. If she wishes to travel then an external weather provider will be queried for the weather information that occur in the user's travel destination. Thus, this represents an example of the triggering condition.

c. The external service will respond with such information and this will be fed to the process that creates a new message, a subsequent response to the original request that initiated this process. In this use the response would resemble this snippet:

HTTP request:
POST {address} HTTP/1.1
Date: Wed, 11 Nov 2009 10:11:11 GMT
Connection: close
Host: www.example.net
From: analyzer@ericsson.com
Accept; text/html
User-Agent: Mozilla/4.0 (compatible; MSIE 6.0; Windows NT
5.1)
{msg: ″The weather in Sweden is sunny.″}

7. The message generated by the previous policy will be provided by to the original flow we are describing in this example, and based on the information found within the cloned HTTP request, it will be sent back to the public HTTP listener of the HTTP client that created the original request.

In the following, a further example will be provided illustrating how the invention can be put into practice. According to such example, a use case (also referred to as “advertisement case”) can be portrayed as in the following.

A car dealership represented all over the US, plans to run an advert campaign in order to increase its sales. If a customer sends a message that includes the company name to a friend, while present at any of the car dealerships, the customer will get a discount if he or she decides to buy a car. This will not only require the customer to actually go to the store, giving the car seller a better chance to succeed in selling cars, but it will also let the recipient of the message know about the car dealership. The message (representing an example of the first message) could for example be an IM message or a direct Tweet to a friend. According to this example, the following operations may occur:

1. The end-user discovers the campaign in the local news paper and decides to go and visit the dealership.

2. Positioned at the store he sends a message (first message) to a friend using twitter.

3. The Interception node receives the message and forwards it to the Analysis node.

4. The analysis node, which in this specific embodiment is implemented by means of a composition engine (representing a further example of the network entity 30, 520, 620 or 720), would retrieve a policy from the policy database, in this case an application skeleton that would contain the instructions on how to invoke a service for identifying the pattern in the message (this representing an example of the examination discussed above), triggering on the car dealership name. This trigger will in turn invoke a service locating the sender, making sure that the message is actually sent from one of the car stores:

5. A new message will be created containing a unique discount code and it will be send back to the original user.

6. An advertisement message is sent to the message receiver containing more information about the car dealership and its current campaign.

The present invention achieves many advantages over the prior art, as for instance:
Enriching existing services with added end user value.
Allowing end-user to control service behavior and not only service provider as traditional mashups/services.
Easy integration with existing services. Twitter, RSS, Chats etc. . . . are all target applications to which the invention could be applied to.
The solution will enable one single united control/trigger user interaction language that will be suitable for many services.

In the above description, reference has been made to network entities or component entities (like controller entity, invoker entity, etc. . . . ). It is noted that these entities can be indifferently implemented in one network node or network device or may be implemented in a plurality of network nodes of devices in which the necessary functionalities are distributed in a suitable way. Such implementation may further be in hardware, software or any suitable combinations thereof.

Moreover, as evident to the reader, the several embodiments and features thereof can be exchanged as necessary. The several examples may be further combined as necessary, as the reader would recognize that any combination thereof (or of parts thereof) is possible without any need to substantial modifications to what has been described.

The invention has been described in relation to particular embodiments and examples which are intended in all aspects to be illustrative rather than restrictive. Those skilled in the art will appreciate that many different combinations of hardware, software and firmware will be suitable for practicing the present invention. Moreover, other implementations of the invention will be apparent to those skilled in the art from consideration of the specification and practice of the invention disclosed herein. It is intended that the specification and the examples be considered as exemplary only. To this end, it is to be understood that inventive aspects lie in less than all features of a single foregoing disclosed implementation or configuration. Thus, the true scope and spirit of the invention is indicated by the following claims.

Where the terms like controller entity, invoker entity or other entities are used herewith, no restriction is made regarding how distributed these elements may be and regarding how gathered elements may be. That is, the constituent parts of a unit or element or entity may be distributed in different software or hardware components or devices for bringing about the intended function. A plurality of distinct elements may also be gathered for providing the intended functionalities.

Any one of the above-referred units of a network entity, or an element, or a network device, or a network node, etc. . . . may be implemented in hardware, software, field-programmable gate array (FPGA), application-specific integrated circuit (ASICs), firmware or the like.

In further embodiments of the invention, any one of the above-mentioned and/or claimed parts like controller or receiver (this list being not exhaustive) may be replaced by corresponding controlling means or receiving means.

1-17. (canceled)

18. A method for dynamic execution of internet services, comprising:
intercepting a first message sent from a source entity to a destination entity to obtain an intercepted message;
examining the content of the intercepted message to create an examination result;
determining whether at least one triggering condition is provided based on the intercepted message, the triggering condition associated with execution of at least one internet service;
based on determining that the at least one triggering condition is provided, invoking the at least one internet service;
creating a second message based on the at least one invoked internet service;
wherein the determining comprises determining that the trigger condition is provided when the examination result satisfies predetermined conditions.

19. The method of claim 18 wherein the content of the intercepted message represents information provided by a user.

20. The method of claim 19 wherein the predetermined conditions are selected based on the examination result.

21. The method of claim 18:
wherein the examining the content of the intercepted message comprises examining according to predetermined semantic rules;
wherein the predetermined semantic rules express a correlation between content of the intercepted message and internet services.

22. The method of claim 18 further comprising sending the second message to the source entity.

23. The method of claim 18 further comprising sending the second message to the destination entity.

24. The method of claim 18 wherein the creating the second message comprises creating the second message additionally based on the first message.

25. A network entity for dynamic triggering of internet services, the network entity comprising:
a message receiver entity configured to receive an intercepted message corresponding to a first message sent from a source entity to a destination entity;
an examining unit configured to examine content of the intercepted message to create an examination result;
a trigger entity configured to generate, in response to the examination result satisfying predetermined conditions, at least one triggering condition associated with execution of at least one internet service.

26. The network entity of claim 25 further comprising:
a controller entity configured to handle at least one reply message corresponding to at least one response generated by the at least one internet service;
a message creator entity configured to create a second message based on the at least one reply message.

27. The network entity of claim 26 wherein:
the trigger entity is further configured to invoke the internet service upon detection of the triggering condition;
wherein the controller entity is further configured to receive at least one response generated by the internet service.

28. The network entity of claim 26 wherein the controller entity is further configured to receive, from another network entity, at least one reply message corresponding to at least one response of the internet service.

29. The network entity of claim 25:
wherein the examining unit is further configured to examine the content of the intercepted messages according to predetermined semantic rules;
wherein the predetermined semantic rules express a correlation between content of the intercepted message and internet services.

30. The network entity of claim 25 wherein the examining unit is further configured to create the examination result based on of a set of rules received from a policy entity.

31. A network entity for dynamic invocation of internet services, comprising:
a database configured to store policies related to execution of internet services;
a controller entity configured to retrieve, from the database, a policy corresponding to a triggering condition received from a further network entity, the triggering condition determined on the basis of an intercepted message;
an invoker entity configured to invoke an internet service, the invoked internet service determined based on the policy;
wherein the controller entity is further configured to:
receive a response from the internet service;
forward a reply message based on the response to the further network element.

32. A system for dynamic execution of internet services, the system comprising:
an intercepting entity configured to intercept a first message sent from a source entity to a destination entity to obtain an intercepted message;
a controlling entity configured to:
determine whether at least one triggering condition is provided based on the intercepted message;
examine content of the intercepted message to create an examination result;
determine that the triggering condition is provided when the examination result satisfies predetermined conditions, the triggering condition associated to execution of at least one internet service;
an invoking entity configured to, in response to determining that the at least one triggering condition is provided, invoke the at least one internet service;
a message creator configured to create a second message based on the at least one invoked internet service.

33. The system of claim 32 further comprising a message transmitter configured to send the second message to at least one of the source entity and the destination entity.

34. A computer program product stored in a non-transitory computer readable medium for performing dynamic execution of internet services, the computer program product comprising software instructions which, when run on a programmable system, causes the programmable system to:
intercept a first message sent from a source entity to a destination entity to obtain an intercepted message;
examine the content of the intercepted message to create an examination result;
determine whether at least one triggering condition is provided based on the intercepted message by determining that the trigger condition is provided when the examination result satisfies predetermined conditions, the triggering condition associated with execution of at least one internet service;
based on determining that the at least one triggering condition is provided, invoke the at least one internet service;
create a second message based on the at least one invoked internet service.
